(19) United States
(12) Patent Application Publication
(10) Pub. No.: US 2002/0018163 A1
(43) Pub. Date: Feb. 14, 2002

(54) Anti-static film for display

(76) Inventors: Tomohisa Yamamoto, Shizuoka-shi (JP); Chikara Murata, Shizuoka-shi (JP)

Correspondence Address: ARENT FOX KINTNER PLOTKIN & KAHN, PLLC, Suite 600, 1050 Connecticut Avenue, N.W., Washington, DC, 20036-5339, US

(21) Appl. No.: 09/845,255

(22) Filed: May 1, 2001

(30) Foreign Application Priority Data
May 2, 2000 (JP) 2000-133184

(51) Int. Cl. G02F 1/1333

(52) U.S. Cl. 349/122

(57) ABSTRACT

The present invention provides an anti-static film provided with a hard coat layer in which superior optical properties, physical properties, and anti-static properties are maintained, and in addition, in which reflectivity is reduced and interference unevenness is prevented. The anti-static film is produced by providing a hard coat layer on the surface of a transparent substrate directly or via another layer, in which the hard coat layer contains at least resin, conductive material, and low refractive index material, surface electric resistance thereof is 1.0×10¹¹ Ω/□ or less, and the Y value thereof obtained by 5 degree specular reflectance is 4.0% or less.

### BACKGROUND OF THE INVENTION

The present invention relates to an anti-static film which is suitable for use in displays such as liquid crystal displays (LCDs), plasma displays (PDPs), CRTs, ELs, etc., and in particular, relates to an anti-static film having no interference unevenness and having superior anti-static properties.

Displays typified by LCDs, PDPs, CRTs, and ELs are widely used in various fields such as television and computer technologies, and have been developed rapidly. In particular, LCDs are in remarkably common use in lap-top-type personal computers and word processors, portable telephones, PHSs, various portable terminals, etc., as displays which are thin, light, and extremely versatile.

In the past, in such displays, although a hard coat layer had been formed to prevent damage to the surface, etc., there was a problem in that contamination such as dust, etc., adhered by static electricity occurring on the surface since an insulating resin is generally used in the hard coat layer. As a method for preventing the static electricity on the surface of the display, specifically, a method in which a hard coat layer, which was made to have an anti-static property by dispersing conductive fine particles such as metal microparticles, was provided on the surface of the transparent substrate directly or via another layer, and was typically used.

However, since the conductive fine particle is a material having a very high refractive index, the refractive index of the hard coat layer is higher than that of the transparent substrate, and therefore there was a problem in that reflectivity thereof was also increased with the increase of the refractive index. Additionally, there was also a problem in which interference unevenness occurs due to increase in the difference between refractive indexes of the transparent substrate and the hard coat layer. Until now, in order to solve this interference unevenness, trials were done in which reflectivity was reduced by roughening the surface of the hard coat layer, and the interference unevenness was thereby improved; however, the haze value was increased and image contrast was lowered, and the anti-static film was not suitable for practical use.

### SUMMARY OF INVENTION

Therefore, the present invention has been made in view of the above circumstances, and it is an object thereof to provide an anti-static film provided with a hard coat layer in which superior optical properties, physical properties, and anti-static properties are maintained, and in addition, reflectivity is reduced and interference unevenness is prevented.

The inventors have conducted various research in order to prevent interference unevenness from occurring on an anti-static film for a display provided with a hard coat layer and consequently, they have found that by adding a low refractive index material having a specific particle size with conductive material to resin, reflectivity is reduced, and therefore interference unevenness can be prevented from occurring on the surface of the film without affecting conventional superior optical properties and physical properties.

Therefore, an anti-static film for a display according to the present invention is characterized in that a hard coat layer containing at least resin, conductive material, and low refractive index material is provided on the surface of a transparent substrate directly or via another layer, surface electric resistance of the hard coat layer is 1.0×10¹¹ Ω/□ or less, and the Y value thereof obtained by 5 degree specular reflectance is 4.0% or less. The expression “Y value obtained by 5 degree specular reflectance” in the present invention refers to a Y₁₀ value of tristimulus values of the non-luminous object color by reflection in a X₁₀Y₁₀Z₁₀ calorimetric system, and to a Y value luminosity-corrected in accordance with Japanese Industrial Standard Z-8701.

In addition, an anti-static film of the present invention is an anti-static film for display in which an adhesion layer is provided on a surface, in which a hard coat layer is not provided, of a transparent substrate, and is characterized in that at least two layers of these layers are colored and these colors are made to be achromatic by mixing. That is, at least one layer colored so as to have a relationship of complementary color against the color of a hard coat layer colored by conductive material, is provided in the anti-static film. The colored layer may be a transparent substrate or adhesion layer. Thereby, the overall color of the anti-static film for display can be made to be achromatic, and superior anti-reflection property and prevention of interference unevenness, and in addition, superior contrast and color of image, can be obtained.

In the following, laminated compositions and materials which constitute an anti-static film for a display of the present invention will be explained in detail.

A. Transparent Substrate

As a transparent substrate employed in an anti-static film according to the present invention, a conventional transparent film, glass, etc., can be employed. Specifically, various resin films such as polyethylene terephthalate (PET), triacetyl cellulose (TAC), polyacrylate, polyimide, polyether, polycarbonate, polysulfone, polyether sulfone, cellophane, aromatic polyamide, polyethylene, polypropylene, polyvinyl alcohol, and the like, and glass based materials such as fused glass, soda glass, and the like can be preferably employed. For PDPs and LCDs, PET and TAC are preferred.

The higher the transparency of the transparent substrate, the better the transparent substrate. The light transmittance (Japanese Industrial Standard C-6714) is preferably 80% or more, and is more preferably 90% or more. In the case in which the transparent substrate is employed in a compact and light-weight liquid-crystal display, the transparent substrate is preferably in the form of a film. It is desirable that the transparent substrate be thin from the standpoint of being light-weight, and it is preferred that the thickness of the transparent substrate be preferably 10 to 700 μm in consideration of the productivity thereof.

In addition, the adhesion between the hard coat layer and the transparent substrate can be improved by surface-treatment of the transparent substrate such as an alkaline treatment, corona treatment, plasma treatment, fluorine treatment, sputtering treatment, or the like, a coating, on the transparent substrate, of a surface active agent, a silane coupling agent, or the like, or a surface-modification-treatment such as an Si deposition or the like.

B. Hard Coat Layer

Next, a hard coat layer in the present invention is explained.

In the hard coat layer, at least resin, conductive material, and low refractive index material are contained. The materials are combined by appropriately selecting components and mixing ratios, and the hard coat layer is thereby formed so that surface electric resistance thereof is 1.0×10¹¹ Ω/□ or less, and the Y value thereof obtained by 5 degree specular reflectance is 4.0% or less.

The smaller the surface electric resistance and the Y value in the present invention, the better the effects achieved by the present invention. When the surface electric resistance of the hard coat layer exceeds the above value, a superior anti-static property is not obtained, and in addition, when the Y value exceeds 4.0%, a problem occurs in which interference unevenness is substantial. Suitable control of the surface electric resistance and the Y value as described in the above is carried out by appropriately adjusting the types of the conductive material and low refractive index material and the mixing ratio thereof. That is, it is preferable to increase the mixing ratio of the conductive material in order to decrease the surface electric resistance; however, in this case, the Y value is also increased and interference unevenness easily occurs. In contrast, it is preferable to increase the mixing ratio of the low refractive index material in order to decrease the Y value; however, in this case, the surface electric resistance is increased. Furthermore, when the mixing ratio of the conductive material also increases in order to be a desired surface electric resistance by holding down the increase of the surface electric resistance, the Y value tends to increase and the mixing ratio of pigment components consisting of conductive material and low refractive index material in the hard coat layer increases, and therefore the total light transmittance (Tt) is lowered and problems occur in visibility.

Therefore, in the present invention, the desired surface resistance value and the Y value are achieved by appropriately controlling kinds and mixing ratios of conductive material and low refractive index material used in a hard coat layer without deteriorating superior total light transmittance for display, and thereby reflectivity is held down to a low level and superior optical properties in which there is no interference unevenness and there is superior anti-static properties can be achieved.

In the following, each material is specifically explained.

\mathring{1} Resin

As a resin for forming the hard coat layer, resins for hard coating can be employed. In the present invention, a “hard coat” refers to one having a pencil hardness of H or more described in the following. As the resin, a resin cured by means of radiation or heat, or a combination thereof, can be employed. As a radiation curable resin, compounds appropriately mixed with monomers, oligomers, or prepolymers having polymeric unsaturated bonds such as for an acryloyl group, methacryloyl group, acryloyloxy group, methacryloyloxy group, or the like, can be employed. As a monomer, acrylic acid derivatives of monofunctional acrylates such as styrene, methyl acrylate, lauryl acrylate, ethoxy diethylene glycol acrylate, methoxy triethyleneglycol acrylate, phenoxy ethylacrylate, tetrahydrofurfuryl acrylate, isobornyl acrylate, 2-hydroxyethyl acrylate, 2-hydroxypropyl acrylate, 2-hydroxy-3-phenoxy acrylate, or the like; and of multifunctional acrylates such as neopentylglycol diacrylate, 1,6-hexanediol diacrylate, trimethylolpropane triacrylate, pentaerythritol triacrylate, pentaerythritol acrylate, dipentaerythritol hexaacrylate, trimethylolpropane acrylic acid benzoate, trimethylolpropane benzoate, or the like; methacrylic acid derivatives of monofunctional methacrylate such as methyl methacrylate, 2-ethylhexyl methacrylate, n-stearyl methacrylate, cyclohexyl methacrylate, tetrahydrofurfuryl methacrylate, phenoxyethyl methacrylate, methoxy polyethylene methacrylate, 2-hydroxyethyl methacrylate, 2-hydroxybutyl methacrylate, etc.; and of multifunctional methacrylates such as 1,6-hexanediol dimethacrylate, trimethylolpropane trimethacrylate, glycerol dimethacrylate, ethylene glycol dimethacrylate, or the like; a monomer and an oligomer such as a urethane acrylate such as glycerin dimethacrylate hexamethylene diisocyanate, pentaerythritol triacrylate hexamethylene diisocyanate, or the like; can be mentioned. As an oligomer or prepolymer, an acrylate such as polyester acrylate, polyurethane acrylate, epoxy acrylate, polyether acrylate, alkyd acrylate, melamine acrylate, silicone acrylate, or the like, an unsaturated polyester, an epoxy-type compound, or the like, can be mentioned. These can be employed alone or in combination. In the case in which flexibility of the curing film is required, the amount of monomer employed is reduced. Furthermore, in order to reduce cross-linking density, it is preferable that an acrylic monomer having mono-functional or bi-functional acrylate be employed. Whereas in the case in which hard durability such as thermal resistance, wear resistance, solvent resistance, or the like, is required in the curing film, it is preferable that the amount of monomer be increased or that an acrylic monomer having a tri-functional or greater acrylate be employed.

In order to cure the radiation curable resin as described above, for example, it is necessary that radiation such as UV, electron beams, X-rays, or the like, be irradiated on the resin, and a polymerization initiator can be appropriately added to the resin, as necessary. In the case of curing by means of irradiating with UV, a photopolymerization initiator must be added. As a photopolymerization initiator, an acetophenone such as diethoxy acetophenone, 2-hydroxy-2-methyl-1-phenylpropan-1-one, benzyl dimethyl ketal, 1-hydroxycyclohexyl-phenylketone, 2-methyl-2-monophorino (4-thiomethylphenyl) propan-1-one, or the like; a benzoin ether such as benzoin methylether, benzoin ethylether, benzoin isopropylether, benzoin isobutylether, or the like; a benzophenone such as benzophenone, o-benzoyl methyl benzoate, 4-phenyl benzophenone, 4-benzoyl-4′-methyl-diphenylsulfide, 4-benzoyl-N,N-dimethyl-N-[2-(1-oxo-2-propenyloxy) ethyl] benzene methanaminuim bromide, (4-benzoylbenzyl) trimethyl ammonium chloride, or the like; a thioxanthone such as 2,4-diethyl thioxanthone, 1-chloro-4-dichloro thioxanthone, or the like; 2,4,6-trimethylbenzoyl diphenylbenzoyl oxide, or the like; can be mentioned. These can be employed alone or in combination. In addition, as an accelerator (sensitizer), an amine-type compound such as N,N-dimethyl paratoluidine, 4,4′-diethylamino benzophenone, or the like, can be employed in combination. The content of the photopolymerization initiator is preferably in an amount of 0.1 to 10.0% by weight to the radiation curable resin. If the content is not in this range, UV-curing is insufficient.

In the present invention, an epoxy-type compound cured by UV-rays can be employed as a radiation curable resin and a cationic polymerization initiator can be employed as a photopolymerization initiator. In particular, in the case in which a TAC film is employed as a transparent substrate, the epoxy-type compound and the cationic polymerization initiator are preferably employed since superior adhesion to the TAC film can be exhibited.

As an example of epoxy-type compounds, a glycidyl ether such as tetramethylene glycol diglycidyl ether, propylene glycol diglycidyl ether, neopentyl glycol diglycidyl ether, bisphenol A diglycidyl ether, or the like, an epoxy ester such as 2-hydroxy-3-phenoxypropyl acrylate, an adduct of bisphenol A-diepoxy-acrylic acid, or the like, as well as a monomer and an oligomer such as an alicyclic epoxy represented by the following formulas, can be mentioned.

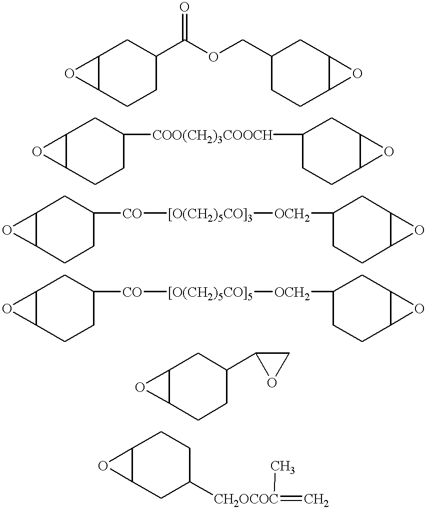

As a photo-cationic polymerization initiator, compounds represented by the following formulas can be employed. In the following formulas, R₁ and R₂ represent an alkyl group having one to six carbon atoms. Benzene rings in the following formulas may have any substituent. As a substituent, an alkyl group having one to six carbon atoms, halogen, etc., can be mentioned. These can be employed alone or in combination.

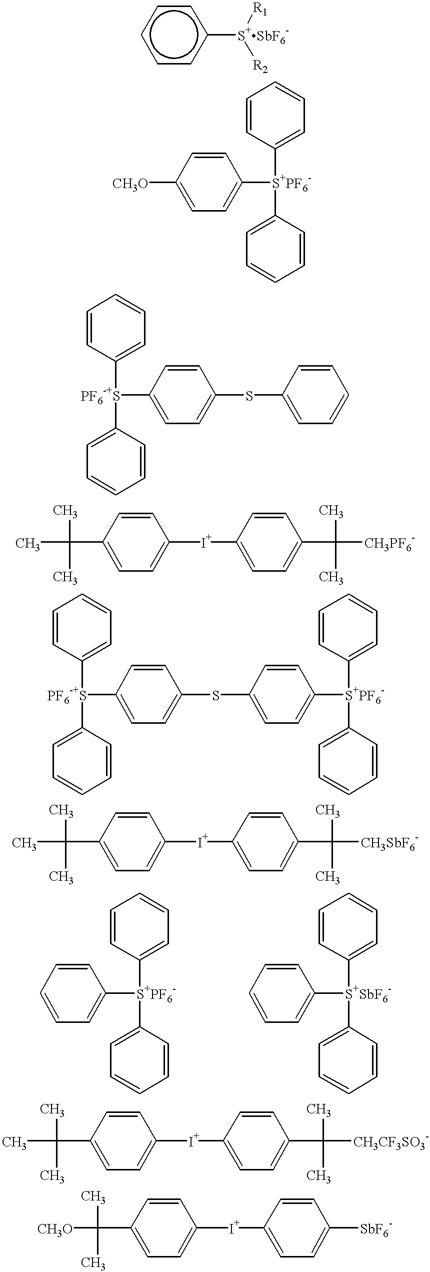

The volumetric shrinkage ratio associated with curing of the hard coat layer employing the above radiation curable resin (calculated by the following method) is preferably 20% or less. With a volumetric shrinkage ratio of 20% or more, in the case of a film-shaped transparent substrate, the film will curl severely, and in the case of a rigid substrate such as a glass or the like, the adhesion between the substrate and the anti-glare layer will be reduced.

Volumetric shrinkage ratio: D=(S−S′)/S×100

wherein

S: specific gravity before curing

S′: specific gravity after curing

(Specific gravity is measured by the B method picnometer method of Japanese Industrial Standard K-7112.)

In the hard coat layer according to the present invention, a stabilizer (a thermal polymerization inhibitor) for the radiation curable resin such as hydroquinone, p-benzoquinone, t-butylhydroquinone, etc., may be added. It is preferred that the stabilizer be employed in a range of 0.1 to 5.0% by weight to the radiation curable resin.

As a thermosetting resin which can be used in the hard coat layer, phenol resin, furan resin, xylene-formaldehyde resin, ketone-formaldehyde resin, urea resin, melamine resin, aniline resin, alkyd resin, unsaturated polyester resin, epoxy resin, etc., can be employed. These may be employed alone or in combination. In the case in which a transparent substrate consists of plastics, the heat curing temperature cannot be set at a high temperature. In particular, in the case in which PET or TAC is employed, a thermosetting resin which can be cured at 100° C. or less is desirably employed.

It is preferable that the curable resin employed in the hard coat layer have a higher transparency. The light permeability (Japanese Industrial Standard C-6714) is preferably 80% or more and more preferably 90% or more, in the case of the transparent substrate. The anti-reflection property of the anti-static film is affected by the refractive index of the curable resin. The refractive index of the above curable resin is preferably in a range of 1.45 to 1.70, and more preferably in a range of 1.5 to 1.65. With a refractive index outside of the range described above, anti-reflection effects are degraded.

\mathring{2} Conductive Material

As a conductive material contained in the hard coat layer of the present invention, metal microparticles and whiskers such as those of aluminum or tin, microparticles and whiskers such as those of antimony-doped metal oxide such as tin oxide, fillerized charge-transfer complexes produced between an electron donor such as a metal ion or an organic cation and 7,7,8,8-tetracyanoxydimethane, or the like, can be mentioned. Among these, metal oxide, in particular, antimony-doped tin oxide (ATO) is preferably employed.

In addition, the particle size of the conductive material is preferably 5 to 500 nm. Furthermore, in the hard coat layer, the total amount of the conductive material and a low refractive index material described in the following is preferably 10 to 80% by weight and is more preferably 20 to 50% by weight. When the mixing ratio of the conductive material and the low refractive index material is below 10% by weight, good conductivity is not obtained. In contrast, when the mixing ratio exceeds 80% by weight, a problem occurs in that the HAZE value in the hard coat layer is increased and the layer strength is decreased.

\mathring{3} Low Refractive Index Material

A low refractive index material contained in the hard coat layer of the present invention refers to a material in which the refractive index thereof is lower than those of the conductive materials. Specifically, materials in which the refractive index is 1.6 or less, and preferably 1.5 or less, can be suitably employed. As such a low refractive index material, for example, an inorganic low refractive index material in which an inorganic material such as SiO₂ (refractive index: n=1.35 to 1.45), LiF (n=1.4), MgF₂ (n=1.4), 3NaF·AlF₃ (n=1.4), AlF₃ (n=1.4), Na₃AlF₆ (n=1.33), or the like is microgranulated and the microgranules are contained in an acrylic resin, an epoxy resin, or the like; or an organic low refractive index material which contains a fluorine-containing compound, a silicone type organic compound, a thermoplastic resin, a thermosetting resin, a radiation curable resin, or the like, can be employed. In the present invention, among these, in particular, a low refractive index sol is preferable, and specifically, silica sol is preferable.

The silica sol is a sol in which silica microparticles are dispersed in water or an organic solvent, and is produced by a method for condensation of an activated silicic acid which de-alkalizes an alkali metal ion in an alkaline salt of silicic acid by ion exchange, etc., or which neutralizes an alkaline salt of silicic acid with a mineral acid, or by a method for hydrolysis and condensation of an alkoxysilane in an organic solvent in the presence of a basic catalyst. Alternatively, an organic-solvent type silica sol (organosilica sol) obtained by replacing the water in an aqueous silica sol described above with an organic solvent by a distillation method may be employed. These silica sols can be employed in either an aqueous or organic-solvent condition. It is not necessary to completely replace the water with the organic solvent in the case of production of the organic-solvent type silica sol. The silica sol contains a solid component as SiO₂ in a concentration of 0.5 to 50% by weight. Various types of silica ultra-microparticles in the silica sol, such as in a spheroidal form, a needle form, a plate form, or the like can be employed.

In addition, it is desirable that the pH be nearly neutral in consideration of dispersiveness to solvent, etc., since the low refractive index material is generally used by dispersing in organic solvent. The particle size of the low refractive index material is preferably 5 to 500 nm, and more preferably 5 to 300 nm. When the particle size of the low refractive index material is below 5 nm, a reduction effect of reflectivity can be insufficiently obtained. In contrast, when the particle size of the low refractive index material exceeds 500 nm, the haze value is increased and the surface of the film is hazy white, and in addition, conductivity is undesirable and therefore the anti-static property is lowered.

A mixing ratio of the low refractive index material is preferably 15 to 200 weight parts and more preferably 20 to 100 weight parts, to 100 weight parts of the conductive material. When the mixing ratio is below 15 weight parts, reflectivity of the hard coat layer is insufficiently lowered, and therefore interference unevenness cannot be improved. In contrast, when the mixing ratio exceeds 200 weight parts, although interference unevenness is improved, the anti-static property is inferior by lowering an effect of the conductive material, and in addition, problems occur in which the haze value in the hard coat layer is increased and physical properties such as layer strength, etc., are lowered.

\mathring{4} Coating Method for Hard Coat Layer

In the present invention, as a method for forming a hard coat layer, directly or via another layer, on one surface of the transparent substrate, there can be mentioned a method consisting of the steps of: mixing a conductive material, a low refractive index material, and water or an organic solvent in the UV-curable resin described above; dispersing the mixture using a paint shaker, sand mill, pearl mill, ball mill, attritor, roll mill, high-speed impeller disperser, jet mill, high-speed impact mill, ultrasonic disperser, or the like, to form a coating material or an ink; providing one layer on one surface of the transparent substrate by means of a printing method such as a letterpress printing method such as a flexographic printing method or the like, an intaglio printing method such as a direct gravure printing method, offset gravure printing method, or the like, a planographic printing method such as an offset printing method or the like, a stencil printing method such as a screen process printing method or the like, or a coating method such as air doctor coating method, blade coating method, knife coating method, reverse coating method, transfer roll coating method, gravure roll coating method, kiss coating method, cast coating method, spray coating method, slot orifice coating method, calender coating method, electrodeposition coating method, dip coating method, die coating method or the like; thermal-drying the coating or printing layers in the case where a solvent is included; and curing the coating or printing layers by means of radiation (in the case of UV radiation, a photo-polymerization initiator is necessary). In the case where the radiation is an electron beam, an electron beam having an energy of 50 KeV to 1000 KeV emitted from various electron beam accelerators such as a Cockroft-Walton apparatus, Van de Graff apparatus, resonance transformer apparatus, insulating core transformer apparatus, linear type apparatus, dynamitron type apparatus, high-frequency type apparatus, or the like is employed. In the case where the radiation is UV radiation, the UV radiation emitted from the light of an extra-high pressure mercury vapor lamp, high pressure mercury vapor lamp, low pressure mercury vapor lamp, carbon arc lamp, xenon arc lamp, metal halide lamp, or the like can be employed.

In order to improve the coating aptitude or printing aptitude of a coating material and an ink, a levelling agent such as silicone oil or the like, fats and oils such as polyethylene wax, carnauba wax, higher alcohols, bisamide, higher fatty acids, or the like, a curing agent such as isocyanate or the like, an additive such as ultra-microparticles having a particle size of 0.1 μm or less, such as calcium carbonate, silica sol, synthetic mica, or the like, can be employed, as necessary.

The thickness of the hard coat layer is preferably in a range of 0.5 μm to 10 μm, and more preferably in a range of 1 μm to 5 μm. In the case where the thickness of the hard coat layer is less than 0.5 μm, wear resistance of the hard coat layer is degraded, or in the case of a UV-curable resin being employed in the hard coat layer, the resin fails to cure due to oxidation inhibition. In contrast, in the case where the thickness of the hard coat layer is more than 10 μm, curling occurs due to curing-shrinkage of the resin, microcracking occurs in the hard coat layer, or the adhesion between the transparent substrate and the hard coat layer is decreased.

C. Adhesion Layer

As an adhesive employed in an adhesion layer in the present invention, an adhesive in which the adhesive power (180 degree peeling force) in accordance with Japanese Industrial Standard Z-0237 is preferably 1500 g/25 mm or less and more preferably 1000 g/25 mm or less, can be employed by selecting appropriately. Furthermore, as an adhesive, it is desirable that peeling and foaming do not occur in a compulsive aging test under high temperature and high humidity, and in addition, it is preferable that re-peelability be possible and there be no adhesive remaining after peeling. As an adhesive having such properties, acrylic adhesive, rubber adhesive, polyvinyl ether adhesive, silicone adhesive, etc., can be employed by selecting appropriately. Among these, acrylic-type adhesive is the most suitable.

Alkyl (meth)acrylate and polymeric unsaturated carboxylic acid or unsaturated ethylene monomer including hydroxyl group, or alkyl (meth)acrylate and copolymeric vinyl monomer, are copolymerized in organic solvent or aqueous medium, and the acrylic adhesive can thereby be obtained. As a polymerization method, a radical polymerization method, a solution polymerization method, a suspension polymerization method, an emulsion polymerization method, etc., can be employed. With respect to molecular weight of this copolymer, the number average molecular weight by gel permeation chromatography is preferably 10,000 to 1,000,000, more preferably 50,000 to 500,000, and most preferably 100,000 to 400,000. When the number average molecular weight is below 10,000, it is difficult to uniformly form a resin component layer. In contrast, when the number average molecular weight exceeds 1,000,000, elasticity is increased, and therefore problems occur in which it is difficult to adjust the coating amount, or the like.

As an alkyl (meth)acrylate, methyl (meth)acrylate, butyl (meth)acrylate, octyl (meth)acrylate, which have an alkyl group having 1 to 12 carbon atoms, etc., can be employed. Specifically, as a methacrylate component, methyl methacrylate, ethyl methacrylate, n-propyl methacrylate, isopropyl methacrylate, n-hexyl methacrylate, cyclohexyl methacrylate, 2- ethylhexyl methacrylate, n-octyl methacrylate, isooctyl methacrylate, lauryl methacrylate, etc., can be employed. As an acrylate component, methyl acrylate, ethyl acrylate, propyl acrylate, butyl acrylate, n-hexyl acrylate, 2-ethylhexyl acrylate, n-octyl acrylate, lauryl acrylate, etc., can be employed. These can be employed alone or in combination.

In addition, dispersiveness of carbon is improved by using (meth)acrylate monomer having a carboxyl group and/or hydroxyl group as a functional group together with the above alkyl (meth)acrylate. In particular, when acidic carbon is used, the dispersiveness is further improved. As a monomer having such a functional group, (meth)acrylic acid, maleic acid, itaconic acid, and crotonic acid, which have a carboxyl group, 2-hydroxyethyl acrylate, 2-hydroxypropyl acrylate, 2-hydroxy vinyl ether, which have a hydroxyl group, etc., can be employed. These can be employed alone or in combination by mixing with the above (meth)acrylate component.

In these adhesives, crosslinking agents can be also mixed. As a crosslinking agent, isocyanate compound, aluminum chelate, aziridinyl compound, epoxy compound, etc., can be employed. In general, the mixing amount of this crosslinking agent is preferably 0.01 to 10 weight parts to 100 weight parts of the acrylic adhesive. An adhesive as described in the above is dissolved in organic solvent and this solution is coated on a transparent substrate by a coating machine such as roll coater, reverse coater, comma coater, lip coater, dye coater, etc., and thereby an adhesion layer is provided. In this case, a film, paper, or the like, which is subjected to a peeling treatment is laminated to the surface without transparent substrate of the adhesion layer, and convenience in handling can thereby be provided.

In the present invention, since a hard coat layer is generally colored by conductive material, pigment or dye is mixed in a transparent substrate and/or adhesion layer so as to be of complementary color relative to the above color, and the overall color of an anti-static film for display as a final product can be made to be achromatic. “Achromatic” in the present invention refers to a hue in which a value a and a value b are almost similar to zero in Lab hue expressions. Specifically, an achromatic color is preferably a hue in which a value a and a value b are within ±5, respectively, more preferably a hue in which a value a is within ±3 and a value b is within ±4, and most preferably a hue in which a value a is +1 to −2.5 and a value b is within ±3.5. When one of a value a and a value b exceeds the above range, color of display is affected, and therefore image contrast and color reproducibility are deteriorated.

As a pigment, iso-indolinone pigment, anthraquinone pigment, dioxazine pigment, azo pigment, naphthol pigment, quinophthalone pigment, azomethine pigment, benzimidazolone pigment, perynone pigment, pyranthlone pigment, quinacridone pigment, perylene pigment, phthalocyanine pigment, thren pigment can be mentioned. Among these, red pigments such as dioxazine pigment, azo pigment, naphthol pigment, quinacridone pigment, and blue pigments such as phthalocyanine pigment are preferable, and as a most suitable pigment, quinacridone pigment, dioxazine pigment, and copper phthalocyanine pigment can be employed. Furthermore, average particle size of these pigments is preferably 0.01 to 5 μm, and more preferably 0.01 to 1 μm.

Although various dyes can be used appropriately as a dye, in the present invention, pigment is further preferably employed since dyes are inferior in weather resistance and changes in light transmittance in use over long period is large.

The HAZE value according to Japanese Industrial Standard K-7105 of the thus-obtained anti-static film according to the present invention is preferably in a range of 3 to 30, and more preferably in a range of 5 to 15. With a HAZE value of less than 3, the light scattering effects are small, and therefore sufficient anti-reflection effects cannot be obtained. On the other hand, with a HAZE value of more than 30, the image contrast is degraded and visibility is degraded, and for these reasons, it is not preferred since an inferior display will result. The HAZE value is a clouding value, and it is calculated according to the following expression by measuring a luminous diffuse transmittance (Td %) and a total light transmittance (Tt %) using an integrating sphere type light transmittance measuring apparatus.

HAZE value=Td/Tt×100

### BRIEF DESCRIPTION OF THE DRAWING

FIG. 1 is a schematic cross-sectional drawing showing a structure of an anti-static film according to the present invention.

### DETAILED DESCRIPTION OF THE PREFERRED EMBODIMENTS

In the following, an anti-static film for a display according to the present invention will be explained in detail with reference to the accompanying drawings.

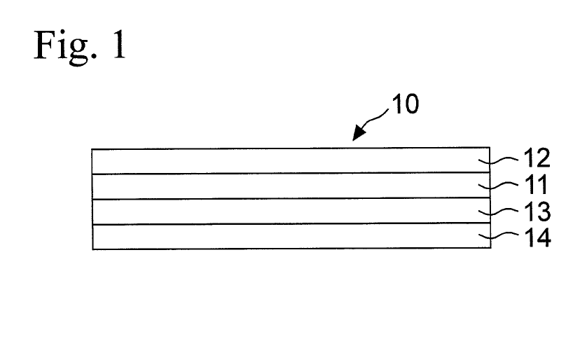

FIG. 1 is a schematic cross-sectional drawing showing a structure of an anti-static film for a display in accordance with an aspect of the present invention. The anti-static film 10 comprises a transparent substrate 11, a hard coat layer 12 formed on one surface of the transparent substrate 11, a color adhesion layer 13 formed on the other surface of the transparent substrate 11, and a separation film 14 further provided on the surface of the color adhesion layer 13.

### EXAMPLES

The present invention will be explained in more detail by Examples. In the following, “parts” refer to “parts by weight”.

Polymerization of Acrylic Polymer a

Acrylic Polymer a

94 parts of n-butyl acrylate, 6 parts of acrylic acid, 0.3 parts of benzoyl peroxide, 40 parts of ethyl acetate, and 60 parts of toluene were added in a flask having a thermometer, a stirrer, a reflux condenser, and a nitrogen feeding tube. The flask was filled with nitrogen by feeding nitrogen thereinto through the nitrogen feeding tube, and was heated to 65° C., and the polymerization reaction was allowed to proceed for 10 hours. An acrylic polymer solution having a weight average molecular weight of about 1,200,000 (a number average molecular weight of about 300,000) and a Tg of about −49° C. was thereby obtained. Subsequently, ethyl acetate was added in this acrylic polymer solution, and therefore, an acrylic polymer a (solid concentration of 20% by weight) was prepared.

### Example 1

A dispersion liquid obtained by dispersing a mixture of conductive material, low refractive material, and the like at composition ratio described below, using a pearl mill for 30 minutes, and a base coating material, described below, were stirred for 15 minutes with a disper. The mixed coating material was coated on one surface of polyethylene terephthalate (trade name: Merinex 535, produced by Teijin Du Pont Co., Ltd.) which is a transparent substrate having a film thickness of 188 μm and a transmittance of 91%, by means of a reverse coating method and was subsequently dried for 30 seconds at 100° C. Subsequently, the film was irradiated with UV radiation to cure the coating film, under the conditions of output powder: 120 W/cm, radiation distance (distance between the center of the lamp and the coating face): 10 cm, treatment speed (speed with respect to the mercury lamp at the coating substrate): 10 m/min, using one converging type high-pressure mercury lamp. Therefore, a hard coat layer having a thickness of 7.1 μm was formed.

Composition of the dispersion liquid

Conductive material

Tin oxide (trade name: SN 100, produced by Ishihara Sangyo Kaisha, Ltd.; particle size 100 nm), 55 parts

Low refractive index material

Silica sol (trade name: OSCAL special, produced by Catalysts & Chemicals Industries Co., Ltd.; solid concentration in Methylethylketone (MEK) diluent 20%, particle size 7 nm), 65 parts

Titanate-type dispersing agent (trade name: T-50, produced by Nippon Soda Co., Ltd.), 2 parts

MEK, 290 parts

Isobutanol, 220 parts

Diacetone alcohol, 70 parts

Composition of the base coating material

UV curable resin (trade name: Unidic 17-806, produced by Dainippon ink and Chemicals, Inc.; solid concentration 80%), 250 parts

Photopolymerization initiator (trade name: Irgacure 907, Chiba Specialty Chemicals K. K.), 10 parts,

MEK, 145 parts

Next, 0.1 parts of N,N,N′,N′-tetraglycidyl-m-xylene diamine was added to 500 parts of the above acrylic polymer solution a, and an adhesive coating solution a′ was obtained. In addition, 6 parts of color pigments (carbon black/dioxane violet/monochloro cyanine blue=75/12.5/12.5) were added to 500 parts of another acrylic polymer solution a and were stirred, and a color pigment solution A in which the color pigments were sufficiently dispersed therein was produced.

0.2 parts of the color pigment solution A was added to 100 parts of the adhesive coating solution a′ (adhesive solid concentration 20% by weight), and was stirred so as to be uniform. Subsequently, the mixture was coated on a PET film which was subjected to peeling treatment having a thickness of 38 μm so that a thickness of a color adhesive layer after drying was 20 μm, and was dried. Next, the surface of the coloring adhesive layer was adhered to a surface, in which a hard coat layer was not provided, of the above transparent substrate, and an anti-static film was thereby obtained.

### Example 2

An anti-static film was obtained in the same manner as in Example 1, except that the composition ratio of the hard coat layer was changed to the A following ratio, the thickness of the hard coat layer was made to be 6.8 μm, and the thickness of the coloring adhesive layer was made to be 23 μm.

Composition of the dispersion liquid

Conductive material

Tin oxide (trade name: SN 100, produced by Ishihara Sangyo Kaisha, Ltd.; particle size 100 nm), 50 parts

Low refractive index material

Silica sol (trade name: OSCAL special, produced by Catalysts & Chemicals Industries Co., Ltd.; solid concentration in Methylethylketone (MEK) diluent 20%, particle size 7 nm), 60 parts

Titanate-type dispersing agent (trade name: T-50, produced by Nippon Soda Co., Ltd.), 2 parts

MEK, 450 parts

Isobutanol, 335 parts

Diacetone alcohol, 110 parts

Composition of the base coating material

UV curable resin (trade name: Unidic 17-806, produced by Dainippon ink and Chemicals, Inc.; solid concentration 80%), 225 parts

Photopolymerization initiator (trade name: Irgacure 907, Chiba Specialty Chemicals K. K.), 17 parts,

MEK, 225 parts

### Example 3

An anti-static film was obtained in the same manner as in Example 1, except that the composition ratio of the hard coat layer was changed to the following ratio, the thickness of the hard coat layer was made to be 7.0 μm, and the thickness of the coloring adhesive layer was made to be 25 μm.

Composition of the dispersion liquid

Conductive material

Tin oxide (trade name: SN 100, produced by Ishihara Sangyo Kaisha, Ltd.; particle size 100 nm), 55 parts

Low refractive index material

Silica sol (trade name: OSCAL special, produced by Catalysts & Chemicals Industries Co., Ltd.; solid concentration in Methylethylketone (MEK) diluent 20%, particle size 7 nm), 225 parts

Titanate-type dispersing agent (trade name: T-50, produced by Nippon Soda Co., Ltd.), 2 parts

MEK, 165 parts

Isobutanol, 125 parts

Diacetone alcohol, 40 parts

Composition of the base coating material

UV curable resin (trade name: Unidic 17-806, produced by Dainippon ink and Chemicals, Inc.; solid concentration 80%), 40 parts

Photopolymerization initiator (trade name: Irgacure 907, Chiba Specialty Chemicals K. K.), 2 parts,

MEK, 85 parts

### Comparative Example 1

An anti-static film was obtained in the same manner as in Example 1, except that the composition ratio of the hard coat layer was changed to the following ratio, the thickness of the hard coat layer was made to be 6.5 μm, and the thickness of the coloring adhesive layer was made to be 18 μm.

Composition of the dispersion liquid

Conductive material

Tin oxide (trade name: SN 100, produced by Ishihara Sangyo Kaisha, Ltd.; particle size 100 nm), 65 parts

Titanate-type dispersing agent (trade name: T-50, produced by Nippon Soda Co., Ltd.), 2 parts

MEK, 315 parts

Isobutanol, 235 parts

Diacetone alcohol, 80 parts

Composition of the base coating material

UV curable resin (trade name: Unidic 17-806, produced by Dainippon ink and Chemicals, Inc.; solid concentration 80%), 250 parts

Photopolymerization initiator (trade name: Irgacure 907, Chiba Specialty Chemicals K. K.), 10 parts,

MEK, 160 parts

### Comparative Example 2

An anti-static film was obtained in the same manner as in Example 1, except that the composition ratio of the hard coat layer was changed to the following ratio, the thickness of the hard coat layer was made to be 6.8 μm, and the thickness of the coloring adhesive layer was made to be 28 μm.

Composition of the dispersion liquid

Conductive material

Tin oxide (trade name: SN 100, produced by Ishihara Sangyo Kaisha, Ltd.; particle size 100 nm), 10 parts

Low refractive index material

Silica sol (trade name: OSCAL special, produced by Catalysts & Chemicals Industries Co., Ltd.; solid concentration in Methylethylketone (MEK) diluent 20%, particle size 7 nm), 285 parts

Titanate-type dispersing agent (trade name: T-50, produced by Nippon Soda Co., Ltd.), 2 parts

MEK, 225 parts

Isobutanol, 170 parts

Diacetone alcohol, 55 parts

Composition of the base coating material

UV curable resin (trade name: Unidic 17-806, produced by Dainippon ink and Chemicals, Inc.; solid concentration 80%), 250 parts

Photopolymerization initiator (trade name: Irgacure 907, Chiba Specialty Chemicals K. K.), 10 parts,

MEK, 115 parts

### Comparative Example 3

An anti-static film was obtained in the same manner as in Example 1, except that the composition ratio of the hard coat layer was changed to the following ratio, the thickness of the hard coat layer was made to be 6.3 μm, and the thickness of the coloring adhesive layer was made to be 23 μm.

Composition of the dispersion liquid

Conductive material

Tin oxide (trade name: SN 100, produced by Ishihara Sangyo Kaisha, Ltd.; particle size 100 nm), 60 parts

Low refractive index material

Silica sol (trade name: OSCAL special, produced by Catalysts & Chemicals Industries Co., Ltd.; solid concentration in Methylethylketone (MEK) diluent 20%, particle size 7 nm), 35 parts

Titanate-type dispersing agent (trade name: T-50, produced by Nippon Soda Co., Ltd.), 2 parts

MEK, 300 parts

Isobutanol, 230 parts

Diacetone alcohol, 75 parts

Composition of the base coating material

UV curable resin (trade name: Unidic 17-806, produced by Dainippon ink and Chemicals, Inc.; solid concentration 80%), 250 parts

Photopolymerization initiator (trade name: Irgacure 907, Chiba Specialty Chemicals K. K.), 10 parts,

MEK, 150 parts

With regard to the anti-static films of Examples 1 to 3 and Comparative Examples 1 to 3 as obtained above, surface electric resistance, Lab hue, haze value, total light transmittance, 5 degree specular reflectance, interference unevenness, adhesion and pencil hardness were measured by the following methods and were evaluated.

(1) Surface Electric Resistance

Surface electric resistance of a hard coat layer of each anti-static film was measured by a USR probe, at an applied voltage 250 V, and for a period of 10 seconds using a surface resistivity meter (trade name: Hiresta UP MCP-HT450, produced by Mitsubishi Chemistry Co., Ltd.).

(2) Lab Hue

A PET film subjected to peeling treatment was peeled from each anti-static film, and a value a and a value b of each anti-static film were measured using a spectrophotometer (trade name: visible UV spectroscopy photometer UVDEC-670, produced by Japan Spectroscopy Co., Ltd.).

(3) Haze Value

With respect to each anti-static film provided with a hard coat layer on a transparent substrate before a coloring adhesive layer is formed, the haze value to was measured in accordance with Japanese Industrial Standard K-7105, using a haze meter (trade name: Haze Meter NDH 2000, produced by Japan Electric Color Co., Ltd.).

(4) Total light transmittance

With respect to each anti-static film provided with a hard coat layer on a transparent substrate before a coloring adhesive layer is formed, total light transmittance was measured using a spectrophotometer (trade name: UV3100, produced by Shimadzu Corporation).

(5) 5 Degree Specular Reflectance

With respect to each anti-static film provided with a hard coat layer on a transparent substrate before a coloring adhesive layer is formed, 5 degree specular reflection was measured at wavelengths of 400 to 700 nm, using a spectrophotometer (trade name: UV 3100, produced by Shimadzu Corporation) and was luminosity-corrected in accordance with Japanese Industrial Standard Z-8701, and the reflectivity is shown by a Y value. Here, after the non-measured surface of the film was completely painted with black magic ink, the measurements were carried out.

(6) Interference Unevenness

Each anti-static film was put on a black board so that the surface of a hard coat layer faced upward, and was illuminated from above at 27 W by a three wavelength fluorescent lamp, and the intensity of the interference to unevenness was examined by visual observation. In this evaluation, the following criteria were used: cases where the interference unevenness was not observed: ◯; cases where the interference unevenness was slightly observed: Δ; cases where the interference unevenness was observed to be severe: ×.

(7) Adhesion

Adhesion of each anti-static film was examined in accordance with the cross cut test of Japanese Industrial Standard K-5600. The evaluation was carried out according to cross cut number which did not peel off/total cross cut number.

(8) Pencil Hardness

With respect to each anti-static film provided with a hard coat layer on a transparent substrate before a coloring adhesive layer is formed, pencil hardness was measured in accordance with Japanese Industrial Standard K-5400, using a pencil hardness tester (produced by Yoshimitsu Seiki Co., Ltd.).

The above evaluated results are shown in Table 1.

TABLE 1

| | Surface | | | | | | | | |
|---|---|---|---|---|---|---|---|---|---|
| | Electric | | | | | | | | |
| | Resistance | | | | | Y Value | Interference | | Pencil |
| | (Ω/□) | Value a | Value b | Hz (%) | Tt (%) | (%) | Unevenness | Adhesion | Hardness |
| Example 1 | 1.3 × 10⁸ | −1.5 | −0.6 | 1.4 | 82.4 | 3.6 | O | 100/100 | 3H |
| Example 2 | 3.8 × 10⁸ | −1.3 | −0.8 | 1.2 | 82.8 | 3.5 | O | 100/100 | 3H |
| Example 3 | 7.3 × 10⁸ | −1.2 | −0.5 | 1.4 | 81.1 | 3.8 | O | 100/100 | 3H |
| Comparative | | | | | | | | | |
| Example 1 | 1.7 × 10⁸ | −1.5 | −0.7 | 0.9 | 78.3 | 5.0 | X | 100/100 | 3H |
| Comparative | 1.2 × 10¹³ | −1.2 | −0.6 | 12.3 | 84.1 | 2.3 | O | 0/100 | HB |
| Example 2 | | | | | | | | | |
| Comparative | | | | | | | | | |
| Example 3 | 2.2 × 10⁸ | −1.4 | −0.8 | 1.0 | 80.5 | 4.5 | Δ | 100/100 | 3H |

As is apparent from the results shown in Table 1, in anti-static films of Examples 1 to 3 in which low refractive index material was added within the suitable range, superior haze value, total light transmittance, and physical properties (adhesion, and pencil hardness) were maintained and reflectivity was lowered, and interference unevenness on the surface of the film could be thereby prevented from occurring. In contrast, in a conventional anti-static film of Comparative Example 1 containing no low refractive index material, the Y value was high at 5.0%, reflection on the surface of film was remarkable, and interference unevenness was remarkable. In addition, in Comparative Example 2 in which low refractive index material was contained in excess, the Y value was small and interference unevenness was improved; however, surface electric resistance was increased, whereby anti-static property was inferior, and in addition, the haze value was increased and physical properties such as adhesion and pencil hardness were extremely inferior, and therefore, the film was not suitable in practical use. Furthermore, in Comparative Example 3, interference unevenness was not improved since the Y value exceeded 4.0%.

In addition, anti-static films of Examples 1 to 3 of the present invention was adhered to the left half of a screen of a color graphics electronic display for a personal computer, and contrasts of the right and left of the screen was examined by visual observation. As a result, on a portion in which the anti-static film of the present invention adjusted to achromatic color was adhered, it was confirmed that the contrast was improved.

As explained above, according to an anti-static film of the present 1 invention, by adding low refractive index material to a hard coat layer, superior optical properties, physical properties, and anti-static properties are retained, and in addition, reflectivity is reduced and interference unevenness on the surface of the film can thereby be prevented from occurring.

What is claimed is:

1. An anti-static film for a display, comprising a hard coat layer provided on the surface of a transparent substrate directly or via another layer, wherein said hard coat layer contains at least resin, conductive material, and low refractive index material, surface electric resistance thereof is 1.0×10¹¹ Ω/□ or less, and the Y value thereof obtained by 5 degree specular reflectance is 4.0% or less.

2. An anti-static film for a display, in accordance with claim 1, wherein said low refractive index material has a particle size of 5 to 500 nm.

3. An anti-static film for a display, in accordance with claim 1, wherein said low refractive index material is contained at 15 to 200 weight parts to 100 weight parts of said conductive material.

4. An anti-static film for a display, in accordance with claim 1, wherein said low refractive index material is silica sol.

5. An anti-static film for a display, in accordance with claim 2, wherein said low refractive index material is silica sol.

6. An anti-static film for a display, in accordance with claim 3, wherein said low refractive index material is silica sol.

7. An anti-static film for a display, in accordance with claim 1, wherein said conductive material is metal oxide particles.

8. An anti-static film for a display, in accordance with claim 2, wherein said conductive material is metal oxide particles.

9. An anti-static film for a display, in accordance with claim 3, wherein said conductive material is metal oxide particles.

10. An anti-static film for a display, in accordance with claim 4, wherein said conductive material is metal oxide particles.

11. An anti-static film for a display, in accordance with claim 1, wherein an adhesion layer is further provided on a surface, in which said hard coat layer is not provided, of said transparent substrate, at least two layers of said layers are colored, and said colors are made to be achromatic by mixing.

12. An anti-static film for a display, in accordance with claim 2, wherein an adhesion layer is further provided on a surface, in which said hard coat layer is not provided, of said transparent substrate, at least two layers of said layers are colored, and said colors are made to be achromatic by mixing.

13. An anti-static film for a display, in accordance with claim 3, wherein an adhesion layer is further provided on a surface, in which said hard coat layer is not provided, of said transparent substrate, at least two layers of said layers are colored, and said colors are made to be achromatic by mixing.

14. An anti-static film for a display, in accordance with claim 4, wherein an adhesion layer is further provided on a surface, in which said hard coat layer is not provided, of said transparent substrate, at least two layers of said layers are colored, and said colors are made to be achromatic by mixing.

15. An anti-static film for a display, in accordance with claim 7, wherein an adhesion layer is further provided on a surface, in which said hard coat layer is not provided, of said transparent substrate, at least two layers of said layers are colored, and said colors are made to be achromatic by mixing.
